(19) United States
(12) Patent Application Publication
(10) Pub. No.: US 2005/0139466 A1
(43) Pub. Date: Jun. 30, 2005

(54) Electrode structure for a electrochemical cells

(76) Inventor: William M. Morris, Yoakers, NY (US)

Correspondence Address: REVEO, INC., 3 WESTCHESTER PLAZA, ELMSFORD, NY, 10523, US

(21) Appl. No.: 10/975,897

(22) Filed: Oct. 28, 2004

Related U.S. Application Data
(60) Provisional application No. 60/515,293, filed on Oct. 28, 2003.

(51) Int. Cl. H01M 4/46; H01M 12/06

(52) U.S. Cl. 204/280; 429/27; 429/231.6

(57) ABSTRACT

Electrodes for electrochemical cells are provided herein, particularly magnesium and magnesium alloy electrodes. In one aspect of the invention, electrodes are formed by thixotropic molding. Such electrodes, particularly formed of magnesium or magnesium based alloys, have desirable microstructures that alleviate the problems of reaction product adhesion, thereby allowing consistent flow of reaction product and minimizing the likelihood of reaction product clogging and maintaining desirable internal resistance. In addition, the electrodes formed herein have a microstructure that resists flaking.

### CROSS-REFERENCE TO RELATED APPLICATIONS

This application claims the benefit under 35 U.S.C. §119(e) of U.S. Provisional Patent Application Ser. No. 60/515,293 filed on Oct. 28, 2003, entitled “Anode Structure For Metal Air Cell”, which is incorporated by reference herein.

### FIELD OF INVENTION

The present invention relates to electrode structures for electrochemical cells, particularly methods of manufacturing electrode structures for electrochemical cells.

### BACKGROUND OF THE INVENTION

Metal air electrochemical cells are desirable energy sources, particularly for features such as relatively high specific energy (W-H/kg). In general, metal electrode materials (anodes) are oxidized by hydroxide ions formed at an air diffusion electrode (cathode), thereby releasing electrons as electrical energy.

One particularly desirable configuration for metal air electrochemical cells is mechanically rechargeable. Typically, an anode is inserted into a cathode structure, discharged, removed, and replaced with a fresh anode structure.

Magnesium is a desirable anode material due to their low material cost and high energy density. However, existing magnesium anodes are expensive due to the need to include an electrical connection, and the need to form them into a desired shape suitable for use as an anode. Thus, magnesium anodes desirably should be constructed in such a way that they can be produced at relatively low-costs. Further, integration with the cathode structure should be user-friendly to accommodate users of all levels. Electrical interconnection to a replaceable anode also should be low cost.

Conventional interconnections are made in a variety of ways. For example, U.S. Pat. No. 5,024,904 disclosures anodes such as magnesium anodes are that are drilled and tapped, whereby a screw is used to collect current. These tapped holes add cost and complexity in manufacture of the electrodes and in refueling operations. U.S. Pat. No. 4,822,698 includes iron wire embedded in anodes, also increasing overall labor and materials cost. U.S. Pat. No. 5,395,707 shows current collection by direct solder of magnesium to a circuit board, which does not lend itself to refueling operations without significant labor.

Further, the microstructure of a magnesium anode is important. An undesirable microstructure can lead to reaction products that tend to adhere to one another, thereby clogging up the cell and increasing internal resistance. In addition, the wrong microstructure can cause flaking, where unconsumed portions of the anode flake off, thereby decreasing efficiency.

Magnesium anodes for electrochemical cells have conventionally been formed using two different methods: die casting and extruding. Conventional extruded anodes must be flat (i.e., they must not have features extending beyond the plane of the major surface of the electrode plate). Further, conventional die cast anodes have an undesirable microstructure (usually quite porous), and cannot be effectively heat-treated because of their porosity (“blistering” occurs).

Thus, a need exists for an anode and a method of manufacturing for anodes, particularly magnesium based alloy anodes, including those having desirable microstructures, convenient manufacturing capabilities, and convenient electrical connection and disconnection for simple refueling.

### BRIEF SUMMARY OF THE INVENTION

The above-discussed and other problems and deficiencies of the prior art are overcome or alleviated by the several methods and apparatus of the present invention for electrodes for electrochemical cells, particularly magnesium and magnesium alloy electrodes.

In one aspect of the invention, electrodes are formed by thixotropic molding. Such electrodes, particularly formed of magnesium or magnesium based alloys, have desirable microstructures that alleviate the problems of reaction product adhesion, thereby allowing consistent flow of reaction product and minimizing the likelihood of reaction product clogging and maintaining desirable internal resistance. In addition, the electrodes formed herein have a microstructure that resists flaking.

In one embodiment of the present invention, the electrodes may be formed with features in one thixotropic molding step. These features include a protruding current collector, anode support protrusions, and/or electrolyte flow channels. Further, in another embodiment of the present invention, since the features may protrude beyond the plane of the plate of the electrode where the electrochemical reaction occurs, they may conveniently be formed such that plural electrodes may be stacked in a volume conserving manner.

### BRIEF DESCRIPTION OF THE FIGURES

In the drawings, like reference characters generally refer to the same parts throughout the different views. Also, the drawings are not necessarily to scale, emphasis instead generally being placed upon illustrating the principles of the invention.

FIG. 1 shows an electrochemical cell system having a plurality of anodes configured and dimensioned to be inserted in a system module;

FIG. 2 shows a plurality of anodes inserted in the system module;

FIG. 3 shows another example of a module including anodes herein;

FIGS. 4A-4C shows an isometric view, an exploded isometric view, and a side view, respectively, of an electrical interconnection;

FIG. 5 shows another embodiment of an electrical connection;

FIGS. 6A and 6B show an additional feature of the present invention whereby anode plates may be stacked for convenient transport;

FIGS. 7A-7B show isometric views an individual anode; and

FIG. 7C shows a side view of plural anodes detailing channels to facilitate electrolyte and reaction product flow.

### DETAILED DESCRIPTION

The present invention relates to electrode structures for electrochemical cells, particularly methods of manufacturing electrode structures for electrochemical cells.

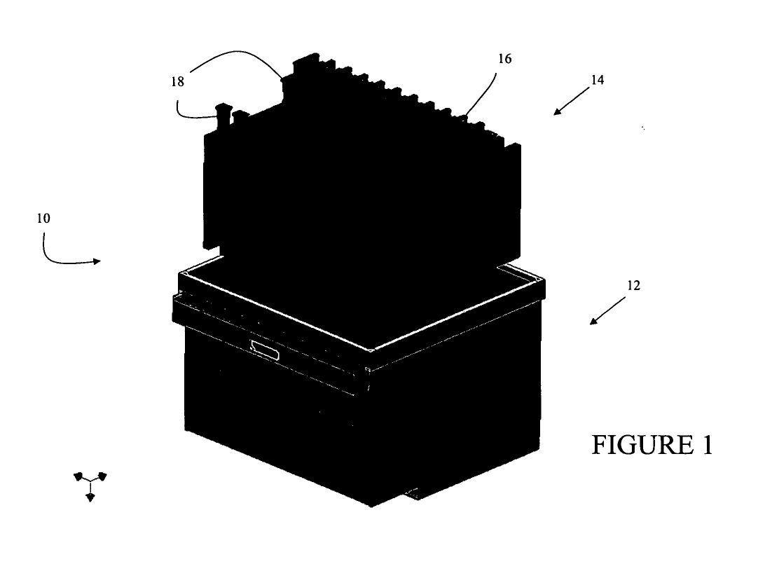

As shown in FIG. 1 an electrochemical cell system 10 is provided having a plurality of electrodes (anodes) 14 configured and dimensioned to be inserted in a system module 12. In certain embodiments, the anodes are configured and dimensioned for removable insertion into the system module 10. The system module generally includes a plurality of cathode structures therein for receiving these anodes 14, as is generally known in the art.

The anodes 14 include specific features to facilitate refueling and interconnection. FIG. 1 shows that each anode 14 includes a pair of anode module support regions 18 (although it is understood that one or more may be used). Further, a current collection region 16 is provided, configured and dimensioned for interconnection with the cathodes of the system modules 12 as described further herein.

In a preferred embodiment, the anodes 14 used herein are molded or cast. One preferred process is known as “thixomolding”. Thixomolding can achieve a microstructure as desirable as extruding, but still have all the advantages of die casting such as low waste and advantageous control of electrode shape.

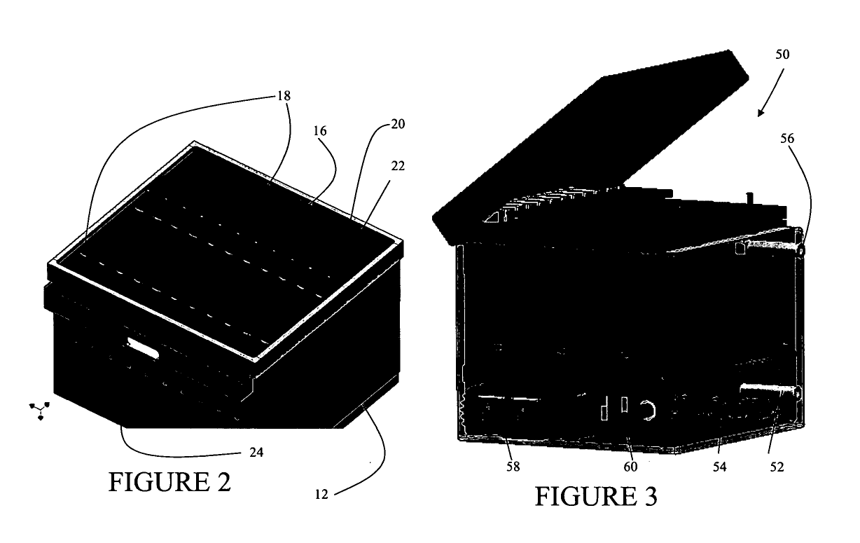

FIG. 2 shows a plurality of anodes 14 inserted in a system module 12, with the protrusions of the current collection regions 16 protruding out of the cell, to allow for an interconnection of the anodes 14 to cathode structures as described herein. The system module includes an anode support structure 20, for example, configured with suitable openings 22 to allow for protrusion of the current collection region 16. Further, the anode support structure may be configured with suitable openings 22 that also allow the anode module support regions 18 to rest thereon for structural support and desirable configuration of the cell when the anodes are inserted (i.e., controlling the depth of insertion of the anodes). The module 10 may also include an electrolyte outlet 24, and an inlet (not shown, generally at the bottom of the module as shown in the figure). In certain embodiments, the anode support structure 20 also serves as sealant for the electrolyte and gases that may escape from the system.

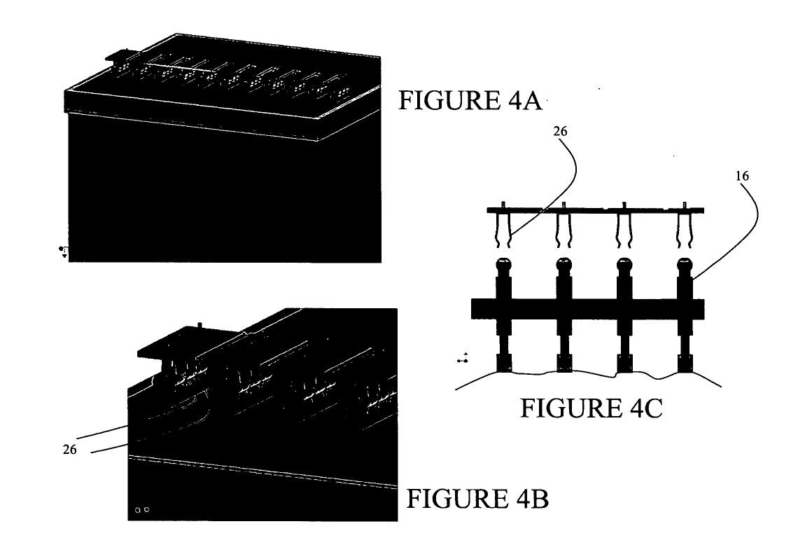

FIG. 3 shows another example of a module 50 including anodes and cathodes described above, and an electrolyte inlet 52, a pump 54, an electrolyte outlet 56, a power inverter 58, and suitable controls 60.

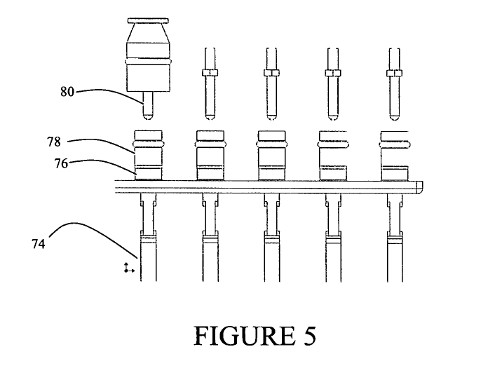

FIGS. 4A-4C shows an isometric view, an exploded isometric view, and a side view, respectively, of an electrical interconnection between the anode current collection regions 16 and spring collectors clips 26. These clips provide a tight conductive connection. For example, conventional fuse holders may advantageously be used as these spring collector clips. A fuse clip is a very inexpensive, mass-produced item, allows for quick connection/disconnection, and is a good, low-resistance connector.

Preferably, when the dimensions of the anode current collection regions 16 is greater than that of the spring connector clips 26 as shown, plural spring connector clips 26 are provided for each anode current collection region. Alternatively, a wider spring connector clip 26 may be used. This is a considerable improvement over conventional metal anodes, whereby electrical connection is made through another metal (male or female) electrical connector (usually a Ni plated copper or brass), and the cathode is connected to the opposite connector. However, in this preferred embodiment, the structure of the anode 14 is itself suitable as an electrical connector.

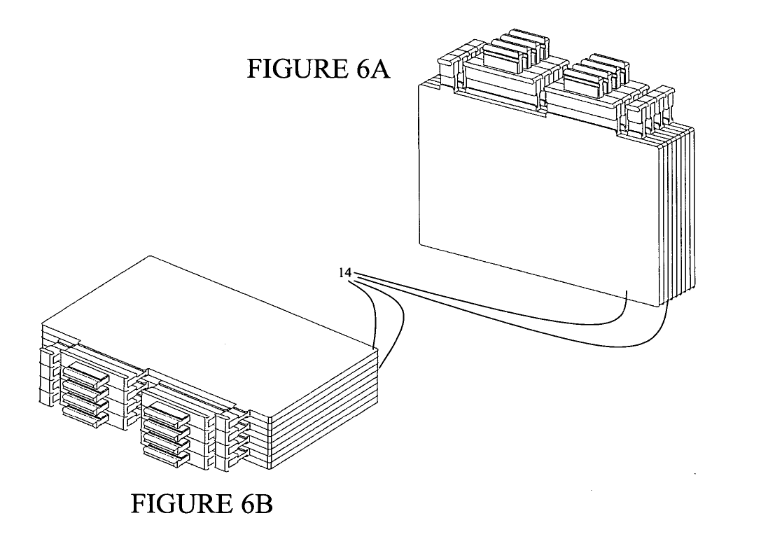

FIG. 5 shows another embodiment providing a hybrid of an anode 74 with a current collector socket 76 integrated with a separate current collector 78. The socket 76 may accept the separate current collector 78 by any suitable mechanical connection, including but not limited to screw threads, welding, soldering, or friction fit. The separate current collector 78 may be any suitable non-corrosive material such as copper, brass, or precious metals. A cathode having a connector 80 may thus be electrically connected. While the configuration is shown as current collector 78 being female and the cathode connector 80 being male, it should be appreciated that the reverse configuration may be used. Further, the current collector 78 may be integrally formed of the anode plate material as described herein, e.g., using thixotropic molding.

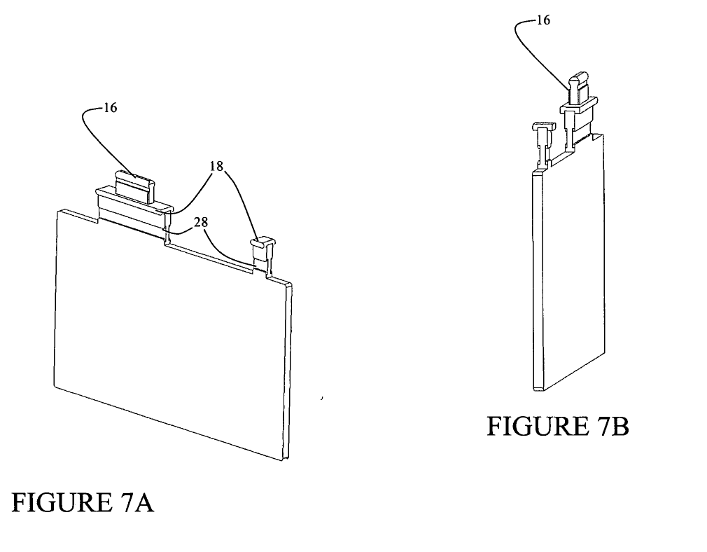

FIGS. 6A and 6B show an additional feature of the present invention whereby anode plates 14 may be stacked for convenient transport of the anode cards. Thus, large amounts of energy may be readily carried to a module in a relatively small volume. In preferred embodiments, wherein the anodes are monolithic, the features allowing stackability are integrally molded therein. That is, the features that protrude beyond the plane of the major surface of the anode plates do not inhibit the stackability, as the plates are stacked as shown in the figures with the current collector regions in alternating manner.

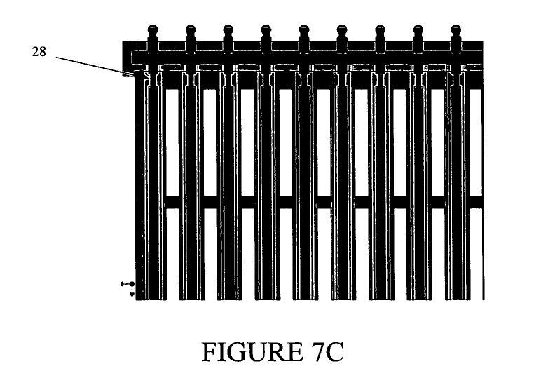

FIGS. 7A-7B show isometric views an individual anode 14 including anode module support regions 18 and the current collection region 16. Further detailed in FIGS. 7A-7C (FIG. 7C providing a side view of plural anodes) shows an additional feature of the anode, wherein channels 28 atop the support structure regions are provided. These channels 28 allow solid product developed during magnesium air electrochemical reactions (generally, magnesium oxides) to be discharged when a suitable electrolyte circulation scheme is employed, such as that shown in FIGS. 2 and 3. FIGS. 7A-7B also clearly show the third dimension of the features including the current collector region, support regions, and channels (i.e., extending beyond the plane of the major surface of the anode plate).

The significant benefits of the current anode include the method of manufacturing, which, inter alia, allows for the creation of the protrusion on top of the anode and other important features. Under existing manufacturing techniques in order for magnesium alloy anodes to perform well, the microstructure must be taking into consideration, because an undesirable microstructure can lead to reaction products that tend to “stick” together, clogging up the cell and increase internal resistance. In addition, an undesirable microstructure can cause “flaking”, where unconsumed portions of the anode “flake” off, decreasing efficiency. Starting off with a densely formed anode, and putting it through a heat-treating process achieves a good microstructure. Presently, magnesium anodes are formed using two different methods: die casting and extruding.

Die cast anodes are usually quite porous, and often cannot be heat-treated at all because of their porosity (“blistering” occurs). Even if they can be heat-treated, the initial structure is too porous, and the results are not ideal. Low performance magnesium anodes (e.g., used as sacrificial anodes) are formed this way.

Unlike die casting, extruded anodes can be made with an ideal microstructure. However, anodes formed using typical extrusion processes are formed as a sheet or plate with parallel major surfaces (i.e., without a third dimension). To create the third dimension, machining is required, which can be a very expensive process: First, an irregular-shaped three dimensional anode (which is what is required to need to incorporate the features described herein such as the anode support region, the current collector region and the flow channels) will result in excessive waste. Second, if the anode is thick (e.g., greater then 4-5 mm), it has to be machined which is a very expensive process. Third, one must design anodes formed according to extrusion processes with parallel sides, which may cause great difficulty for trying to find a simple, cost effective method for collecting current and forming the current collectors.

Therefore, as described herein, the problems of conventional die-casting and extruding are overcome by using the manufacturing process of Thixomolding®. The process of Thixomolding® is essentially the injection molding of thixotropic metal alloys (such as magnesium) in a semi-solid or plastic-like state.

Although a manufacturing procedure is commonly used for plastics Thixomolding® offers a superior alternative to die-casting and extruding. Injection molding of thixotropic metal alloys (e.g., Thixomat, Inc. (Ann Arbor, Mich.) and Thixotech Inc. (Calgary, Alberta, Canada)) allows for convenient and reliable manufacturing of the anode. For example, the thixotropic processing is described in detain in U.S. Pat. Nos. 4,694,881 and 4,694,882 to Thixomat, Inc., which are herein incorporated by reference. The advantage of thixotropic processing is due to its laminar flow and the use of solids. The laminar flow prevents trapped air particles during the molding process thereby reducing porosity. This is in contrast to die casting whereby the molten material is injected or otherwise provided in a more turbulent fashion.

The thixotropically formed electrodes may be used as anode as provided, or alternately they may be subjected to additional heat-treating processes to further enhance the microstructure. For example, solution heat treatment may be employed to relax the microstructure to eliminate inherent stresses therein.

Materials that may be used to form anodes according to the embodiments herein include any magnesium or magnesium alloys that exhibits the thixotropic phase. For example, suitable alloys include, but are not limited to, AZ91 and AM60 magnesuim alloys.

While preferred embodiments have been shown and described, various modifications and substitutions may be made thereto without departing from the spirit and scope of the invention. Accordingly, it is to be understood that the present invention has been described by way of illustrations and not limitation.

1. A magnesium or magnesium based alloy electrode formed by thixotropic molding.

2. A method for manufacturing magnesium or magnesium based alloy electrode comprising thixotropic molding magnesium or magnesium based alloys into a configuration and dimension of an electrode for an electrochemical cell.

3. The method as in claim 2, wherein the electrode is configured and dimensioned as a replaceable electrode.

4. The method as in claim 2, wherein an integral current collection region is formed on the electrode.

5. The method as in claim 2, wherein an integral support region is formed on the electrode.

6. The method as in claim 2, wherein features are formed on the electrode to allow the electrode to be stacked.

7. The method as in claim 4, wherein current collector regions are formed towards one side of the electrode, further wherein features are formed on the electrode to allow the anode to be stacked such that the position of the current collector regions of adjacent electrode in the stack are alternated.

8. The method as in claim 2, wherein an integral reaction product channel is formed on the electrode.

9. A magnesium air electrochemical cell including an air cathode, and electrolyte, and an anode comprising an electrode formed according to any of the methods of claims 2-8.

10. A magnesium air electrochemical cell including an air cathode, and electrolyte, and an anode comprising an electrode formed according to any of the methods of claim 4 or 7, wherein the current collection region of the electrode is configured for receiving a spring connection clip, further wherein a spring connection clip is electrically connected to the cathode and a spring connection region of the spring connection clip removably attaches to the current collection region of the electrode.
